(19) United States
(12) Patent Application Publication
(10) Pub. No.: US 2023/0150313 A1
(43) Pub. Date: May 18, 2023

(54) HEAVY DUTY TIRE

(71) Applicant: Sumitomo Rubber Industries, Ltd., Kobe-shi (JP)

(72) Inventor: Takashi SUGIURA, Kobe-shi (JP)

(73) Assignee: Sumitomo Rubber Industries, Ltd., Kobe-shi (JP)

(21) Appl. No.: 17/989,704

(22) Filed: Nov. 18, 2022

(30) Foreign Application Priority Data
Nov. 18, 2021 (JP) 2021-188085

(51) Int. Cl. B60C 11/03

(52) U.S. Cl. CPC B60C 11/0306; B60C 2200/06; B60C 2011/0355; B60C 2011/0358; B60C 2011/0353; B60C 2011/1213

(57) ABSTRACT

In a tire meridian cross-section in a 5% internal pressure state of a heavy duty tire, a first radius of curvature of a first ground-contact surface profile of each of a center land portion, an inner region of a first middle block, an outer region of the first middle block, and a first shoulder block can be defined. In addition, a ratio (Wa/Da) of a groove width Wa to a groove depth Da of a center circumferential groove may not be larger than 0.25. Furthermore, a ratio (Lb/La) of a maximum length Lb in a tire axial direction to a maximum length La in a tire circumferential direction in the first middle block can be defined.

### CROSS-REFERENCE TO RELATED APPLICATION(S)

The present application claims priority to Japanese Patent App. No. 2021-188085 filed Nov. 18, 2021, wherein the entire content and disclosure of which is incorporated herein by reference.

### BACKGROUND

### Field

The present disclosure relates to a heavy duty tire.

### Background Art

Japanese Laid-Open Patent Publication No. 2018-127199 describes a heavy duty tire including a tread portion demarcated into a center land portion, middle land portions, and shoulder land portions. In the heavy duty tire, a contour line of the surface of the tread portion includes an arc portion that has a radius R1 of curvature and has the arc center disposed on a tire equator, and an arc portion that intersects with the above arc portion at an inflection point P and has a smaller radius R2 of curvature than the radius R1 of curvature, in a 5% internal pressure state. The inflection point P is defined at a predetermined position on the middle land portion. Thus, the heavy duty tire is described as being allowed to have improved center wear resistance under a light load specifications condition.

In recent years, a heavy duty tire has been required to have further improved center wear resistance to prolong a lifespan thereof (hereinafter, referred to as “life performance”).

### SUMMARY

The present disclosure is directed to a heavy duty tire including a tread portion. The tread portion can include: a center land portion a first middle land portion adjacent to the center land portion via a center circumferential groove; a first shoulder land portion adjacent to the first middle land portion via a shoulder circumferential groove and having a first tread end; and a first middle lateral groove and a first shoulder lateral groove that demarcate the first middle land portion and the first shoulder land portion into first middle blocks and first shoulder blocks, respectively. In a 5% internal pressure state in which the heavy duty tire is fitted to a normal rim and adjusted to have 5% of a normal internal pressure, a first radius R1 of curvature of a first ground-contact surface profile of the center land portion, a second radius R2 of curvature of a second ground-contact surface profile of an inner region of the first middle block in a tire axial direction, a third radius R3 of curvature of a third ground-contact surface profile of an outer region of the first middle block in the tire axial direction, and a fourth radius R4 of curvature of a fourth ground-contact surface profile of the first shoulder block can satisfy the following formulas (1) to (3). A groove depth of each of the center circumferential groove and the shoulder circumferential groove may be not smaller than 21 mm. A ratio (Wa/Da) of a groove width Wa of the center circumferential groove to a groove depth Da of the center circumferential groove can be not larger than 0.25. A ratio (Lb/La) of a maximum length Lb in the tire axial direction to a maximum length La in a tire circumferential direction in each first middle block can be larger than 0.75.

0.95≤(R1/R2)≤1.05 (1)

0.95≤(R3/R4)≤1.05 (2)

R1>R3 (3)

### BRIEF DESCRIPTION OF THE DRAWINGS

FIG. 1 is a tire meridian cross-sectional view of a heavy duty tire according to one or more embodiments of the present disclosure;

FIG. 2 is a development of a tread portion of the tire in FIG. 1;

FIG. 3 is a diagram illustrating a ground-contact surface profile in a 5% internal pressure state;

FIG. 4 is a conceptual perspective view of a three-dimensional sipe;

FIG. 5 is a plan view of a tread portion according to another embodiment of the present disclosure; and

FIG. 6 is a cross-sectional view taken along a line A-A in FIG. 5.

### DETAILED DESCRIPTION

An embodiment of the present disclosure will be described below with reference to the accompanying drawings.

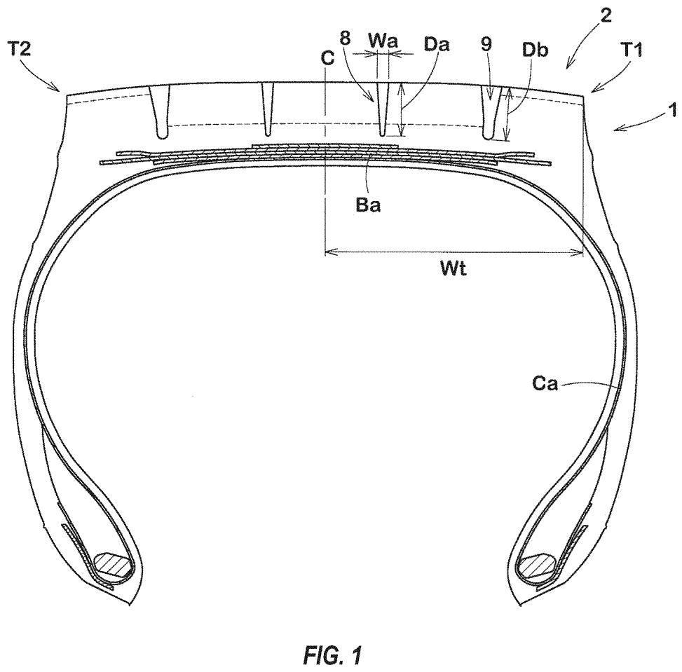

FIG. 1 is a tire meridian cross-sectional view including a tire rotation axis in a normal state of a heavy duty tire (hereinafter, also referred to simply as “tire”) 1 of the present embodiment. The present disclosure can be, for example, applied to the tire 1 having an aspect ratio of 70 to 90%.

The “normal state” can refer to or be regarded as a state in which the tire 1 is fitted to a normal rim and is inflated to a normal internal pressure, and no load is applied to the tire 1. Hereinafter, dimensions of parts of the tire 1 and the like are values measured in the normal state, unless otherwise noted.

In a standard system including a standard on which the tire 1 is based, the “normal rim” can be regarded a rim that is defined for each tire by the standard, and can be, for example, the “standard rim” in the JATMA standard, the “Design Rim” in the TRA standard, or the “Measuring Rim” in the ETRTO standard.

In a standard system including a standard on which the tire 1 is based, the “normal internal pressure” can be regarded as an air pressure that is defined for each tire by the standard, and is the “maximum air pressure” in the JATMA standard, for instance, the maximum value indicated in the table “TIRE LOAD LIMITS AT VARIOUS COLD INFLATION PRESSURES” in the TRA standard, or the “INFLATION PRESSURE” in the ETRTO standard.

The tire 1 according to the present embodiment can include therein tire components such as a carcass Ca and a belt layer Ba. The carcass Ca and the belt layer Ba can be, for example, embedded in a tread portion 2.

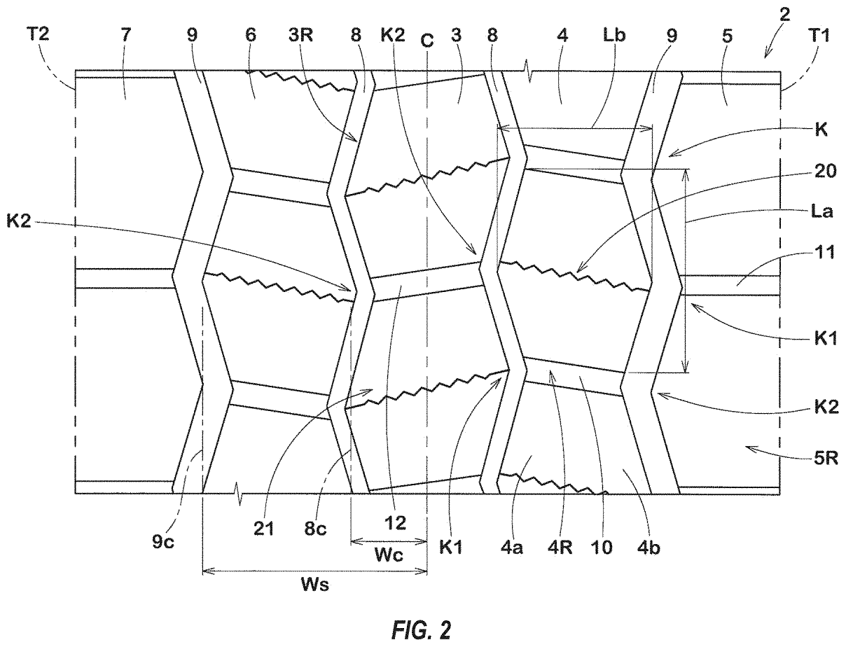

FIG. 2 is a plan view of the tread portion 2 developed on a plane. As shown in FIG. 2, the tread portion 2 can include a center land portion 3 disposed closest to a tire equator C, a first middle land portion 4 disposed adjacent to the center land portion 3, and a first shoulder land portion 5 disposed adjacent to the first middle land portion 4 and having a first tread end T1, in the present embodiment. The center land portion 3 of the present embodiment can be disposed on the tire equator C. The first tread end T1 is shown at a right end of the tread portion 2 in FIG. 2.

The first tread end T1 and a second tread end T2 described below can each be defined or regarded as a tire-axially outermost ground contact position, when the normal load is applied to the tire 1 in the normal state and the tire 1 is brought into contact with a flat surface at a camber angle of 0°. A distance from the tire equator C to the first tread end T1 in a tire axial direction can be a tread half-width Wt (shown in FIG. 1).

The “normal load” can be regarded as a load that is defined for each tire by the standard, and is the maximum load capacity in the JATMA standard, for instance, the maximum value recited in the table “TIRE LOAD LIMITS AT VARIOUS COLD INFLATION PRESSURES” in the TRA standard, or the “LOAD CAPACITY” in the ETRTO standard.

The tread portion 2 of the present embodiment can include a center circumferential groove 8 disposed between the center land portion 3 and the first middle land portion 4, and a shoulder circumferential groove 9 disposed between the first middle land portion 4 and the first shoulder land portion 5. In the present embodiment, the tread portion 2 can include first middle lateral grooves 10 each connecting the center circumferential groove 8 and the shoulder circumferential groove 9 to each other, and first shoulder lateral grooves 11 each connecting the shoulder circumferential groove 9 and the first tread end T1 to each other.

As shown in FIG. 1, a groove depth Da of the center circumferential groove 8 and a groove depth Db of the shoulder circumferential groove 9 can each be not smaller than 21 mm, for instance. The tire 1 including such a center circumferential groove 8 and a shoulder circumferential groove 9 can maintain wet performance for a long period and/or can have basic life performance allowing long-distance running (e.g., 400,000 Km). For example, each of the groove depth Da of the center circumferential groove 8 and the groove depth Db of the shoulder circumferential groove 9 can be not larger than 25 mm.

A ratio (Wa/Da) of the groove width Wa of the center circumferential groove 8 to the groove depth Da of the center circumferential groove 8 can be not larger than 0.25, as an example. In other words, the center circumferential groove 8 can be elongated in a tire radial direction. Such a center circumferential groove 8 can serve to ensure a land ratio of each of the center land portion 3 and the first middle land portion 4 and/or enhance the life performance. If the ratio (Wa/Da) is excessively small, the first middle land portion 4 may fall down onto the center land portion 3 side and thus a ground-contact pressure may be concentrated near the tire equator C. Therefore, the center wear resistance may be reduced. From such a viewpoint, the ratio (Wa/Da) can be not smaller than 0.18, for instance, not smaller than 0.20, and not larger than 0.25.

As shown in FIG. 2, the first middle land portion 4 can be demarcated into first middle blocks 4R by the first middle lateral grooves 10. The first shoulder land portion 5 can be demarcated into first shoulder blocks 5R by the first shoulder lateral grooves 11. The first middle block 4R can include an inner region 4a in the tire axial direction, and an outer region 4b disposed outward of the inner region 4a in the tire axial direction.

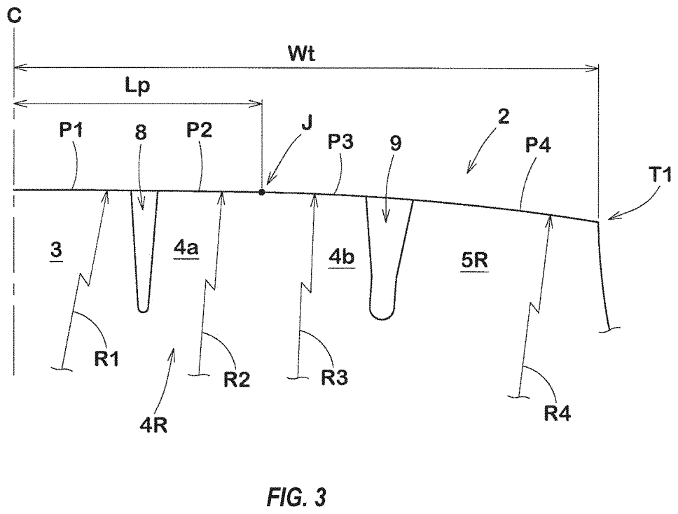

FIG. 3 is a diagram illustrating a ground-contact surface profile (a contour of the tread portion 2) in a 5% internal pressure state of the tire 1. The 5% internal pressure state can be regarded as a state in which the tire 1 is fitted to a normal rim and adjusted to have 5% of a normal internal pressure. The radii R1 to R4 of curvature of the ground-contact surface profiles P1 to P4 of the center land portion 3, the inner region 4a, the outer region 4b, and the first shoulder block 5R can be set or defined to satisfy the following formulas (1) to (3).

0.95≤(R1/R2)≤1.05 (1)

0.95≤(R3/R4)≤1.05 (2)

R1>R3 (3)

When a ratio (R1/R2) is not smaller than 0.95 and not larger than 1.05, the ground-contact surface profile P1 of the center land portion 3 and the ground-contact surface profile P2 of the inner region 4a can be formed so as to smoothly connect with each other, thereby inhibiting concentration of the ground-contact pressure on this part. Accordingly, the center wear resistance can be improved. When a ratio (R3/R4) is not smaller than 0.95 and not larger than 1.05, the ground-contact surface profile P3 of the outer region 4b and the ground-contact surface profile P4 of the first shoulder block 5R can be formed so as to smoothly connect with each other, thereby inhibiting concentration of the ground-contact pressure on this part. Accordingly, any uneven wear resistance can be improved, particularly in the first shoulder block 5R. In addition, when the radius R1 of curvature of the ground-contact surface profile P1 of the center land portion 3 is made larger than the radius R3 of curvature of the ground-contact surface profile P3 of the outer region 4b, the center land portion 3 and the first middle land portion 4 can be evenly worn during straight running and cornering.

When the radius R3 of curvature is excessively smaller than the radius R1 of curvature, the uneven wear resistance in the first middle block 4R may be reduced. Thus, a ratio (R3/R1) of the radius R3 of curvature to the radius R1 of curvature can be not smaller than 0.14, for instance, not smaller than 0.16, and can be not larger than 0.20, for instance, not larger than 0.18. In addition, the radius R1 of curvature can be not smaller than 2500 mm, for instance, not smaller than 2700 mm, and can be not larger than 3500 mm, for instance, not larger than 3300 mm.

For evenly wearing the center land portion 3, the first middle block 4R, and the first shoulder block 5R, the radius R2 of curvature can be smaller than the radius R1 of curvature, and the radius R4 of curvature can be smaller than the radius R3 of curvature. Thus, the circumferential side contour line of the ground-contact shape from the center land portion 3 to the first shoulder block 5R can be maintained to be flattened during load variation. When the circumferential side contour line is flattened, a portion on which the concentrated ground-contact pressure acts can be decreased over the entirety of the tread portion 2, whereby wear can become even to improve the life performance. The flattening can mean that the contour line extends in parallel with the tire axial direction across both ends in the tire axial direction.

The ground-contact surface profile P2 and the ground-contact surface profile P3 can intersect at an inflection point J. The inflection point J can be located on the first middle block 4R. Thus, since the inflection point J is located on the first middle block 4R instead of a position on the circumferential grooves 8 and 9, the smooth connection between the ground-contact surface profile P2 and the ground-contact surface profile P3 can be maintained even after inflating, so that the ground-contact surface profiles P2 and P3 can be inhibited from being changed. Accordingly, the circumferential side contour line of the ground-contact shape from the center land portion 3 to the first middle block 4R can be maintained to be flattened during load variation.

In the present embodiment, the ground-contact surface profiles P1 to P4 can be respectively formed from arcs having the radii R1 to R4 of curvature, that is, they can each be formed from an arc having a single radius of curvature. Each of the ground-contact surface profiles P1 to P4 may have, for example, an arc shape in which a plurality of arcs are combined with each other.

A distance Lp from the tire equator C to the inflection point J in the tire axial direction can be not smaller than 0.35 times the tread half-width Wt, for instance, not smaller than 0.40 times the tread half-width Wt, and can be not larger than 0.50 times the tread half-width Wt, for instance, not larger than 0.45 times the tread half-width Wt. Thus, the circumferential side contour line of the ground-contact shape from the center land portion 3 to the first middle block 4R can be maintained to be flattened even during load variation. Consequently, while shoulder wear of the first middle land portion 4 can be inhibited, the center wear resistance can be improved, particularly even under a light load. The inflection point J may not be formed on the center land portion 3 or the first shoulder block 5R, of the tread portion 2 of the present embodiment. In the present specification, the inflection point J can be regarded as a point where the radius of curvature of the ground-contact surface profile is changed and may not be formed on both ends of the first middle land portion 4 in the tire axial direction.

As shown in FIG. 2, for instance, each first middle block 4R can be formed such that a ratio (Lb/La) of a maximum length Lb in the tire axial direction to a maximum length La in a tire circumferential direction is larger than 0.75, as an example. Thus, since the stiffness (lateral stiffness) of the first middle block 4R in the tire axial direction can be ensured, the first middle block 4R can be inhibited from falling down inward in the tire axial direction. Thus, the ground-contact pressure can be inhibited from being concentrated on the center land portion 3, which can improve the center wear resistance. When the ratio (Lb/La) is excessively large, vertical stiffness of the first middle block 4R may become small. From such a viewpoint, the ratio (Lb/La) can be not smaller than 0.78, and can be not larger than 0.85, for instance, not larger than 0.82.

The tread portion 2 can further include, for example, a second middle land portion 6, which can be disposed adjacent to the center land portion 3 on an opposite side to the first middle land portion 4 in the tire axial direction, and a second shoulder land portion 7, which can be disposed adjacent to the second middle land portion 6 and which can have a second tread end T2. In addition, the tread portion 2 can include a center circumferential groove 8 disposed between the center land portion 3 and the second middle land portion 6, and a shoulder circumferential groove 9 disposed between the second middle land portion 6 and the second shoulder land portion 7, in the present embodiment. Furthermore, the tread portion 2 can include, for example, a plurality of center lateral grooves 12 connecting both the center circumferential grooves 8 to each other. Accordingly, the center land portion 3 can be demarcated by the center lateral grooves 12 to form the center blocks 3R.

The second middle land portion 6 can be formed so as to have the same shape and/or structure as the first middle land portion 4. The second shoulder land portion 7 can be formed so as to have the same shape and/or structure as the first shoulder land portion 5. The center circumferential groove 8, which can be disposed between the center land portion 3 and the first middle land portion 4, and the center circumferential groove 8, which can be disposed between the center land portion 3 and the second middle land portion 6, can be formed so as to have the same shape and/or structure. The shoulder circumferential groove 9, which can be disposed between the first middle land portion 4 and the first shoulder land portion 5, and the shoulder circumferential groove 9, which can be disposed between the second middle land portion 6 and the second shoulder land portion 7, can be formed so as to have the same shape and/or structure. Accordingly, the description for the second middle land portion 6, the second shoulder land portion 7, the center circumferential groove 8, which can be disposed between the center land portion 3 and the second middle land portion 6, and the shoulder circumferential groove 9, which can be disposed between the second middle land portion 6 and the second shoulder land portion 7, is omitted.

A distance We between an amplitude center line 8c of the center circumferential groove 8 and the tire equator C in the tire axial direction can be not smaller than 10% of the tread half-width Wt, for instance, not smaller than 15% thereof, and can be not larger than 30% thereof, for instance, not larger than 25% thereof. A distance Ws between an amplitude center line 9c of the shoulder circumferential groove 9 and the tire equator C in the tire axial direction can be not smaller than 55% of the tread half-width Wt, for instance, not smaller than 60% thereof, and can be not larger than 75% thereof, for instance, not larger than 70% thereof.

Each of the center circumferential groove 8 and the shoulder circumferential groove 9 can extend in a zigzag manner along the tire circumferential direction and has zigzag peak portions K. The zigzag peak portions K can include outward peak portions K1 projecting outward in the tire axial direction and inward peak portions K2 projecting inward in the tire axial direction.

The outward peak portion K1 of the center circumferential groove 8 and the inward peak portion K2 of the shoulder circumferential groove 9 can be arranged side by side in the tire circumferential direction. In addition, the inward peak portion K2 of the center circumferential groove 8 and the outward peak portion K1 of the shoulder circumferential groove 9 can be arranged side by side in the tire circumferential direction,

The first middle lateral groove 10 can connect the outward peak portion K1 of the center circumferential groove 8 and the inward peak portion K2 of the shoulder circumferential groove 9 to each other. Accordingly, the first middle block 4R of the present embodiment can be formed into a barrel-like hexagonal shape in which the center portion in the tire circumferential direction swells toward both sides in the tire axial direction, in a tread planar view. Such a first middle block 4R can have large lateral stiffness, and can thus be inhibited from falling down in the tire axial direction.

The first shoulder lateral groove 11 can extend outward from the outward peak portion K1 of the shoulder circumferential groove 9 in the tire axial direction. Accordingly, the first shoulder block 5R of the present embodiment can be formed into a pentagonal shape in which the center portion in the tire circumferential direction swells inward in the tire axial direction, in the tread planar view.

The center lateral groove 12 can connect between the inward peak portions K2 of the center circumferential grooves 8 on both sides. Accordingly, the center block 3R of the present embodiment can be formed into a barrel-like hexagonal shape in which the center portion in the tire circumferential direction swells toward both sides in the tire axial direction, in the tread portion planar view. Such a center block 3R can have large lateral stiffness and vertical stiffness, which can achieve excellent center wear resistance.

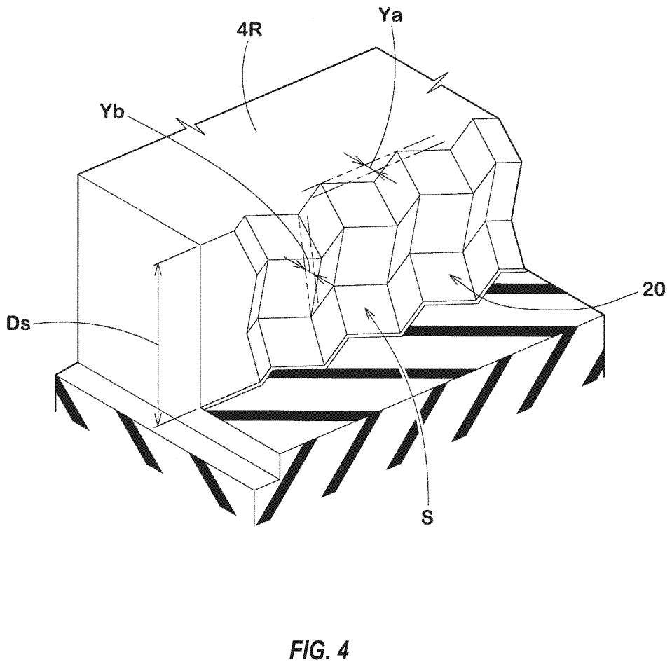

The first middle block 4R can be provided with a first middle sipe 20 crossing the first middle block 4R. The first middle sipe 20 can extend in a zigzag manner along a longitudinal direction and the tire radial direction. Accordingly, the first middle sipe 20 of the present embodiment can be formed as a so-called three-dimensional sipe. FIG. 4 is a conceptual perspective view of the three-dimensional sipe. As shown in FIG. 4, such a sipe can be formed so as to repeat recesses and projections on both sipe wall surfaces S, and thus the recesses and projections can firmly mesh with each other when the tire 1 rolls. Thus, apparent stiffness of the first middle block 4R can be enhanced, and the first middle block 4R can be inhibited from falling down in the tire axial direction, which can improve the center wear resistance. In the present specification, the sipe can be regarded as a slit-like body having a width of less than 1.5 mm, for instance, and can be clearly distinguished from a groove (including a circumferential groove and a lateral groove) having a groove width of 1.5 mm or more, for instance.

A ratio (Ds/Da) of a depth Ds of the first middle sipe 20 to the groove depth Da of the center circumferential groove 8 can be not smaller than 0.6, for instance, not smaller than 0.7, and can be not larger than 0.9, for instance, not larger than 0.8. A ratio (Ya/Yb) of an amplitude Ya (shown in FIG. 4) of the first middle sipe 20 relative to the longitudinal direction to an amplitude Yb of the first middle sipe 20 relative to the tire radial direction can be not smaller than 1.0, for instance, not smaller than 1.1, and can be not larger than 1.3, for instance, not larger than 1.2.

As shown in FIG. 2, the center block 3R can be provided with a center sipe 21 crossing the center block 3R. The center sipe 21 of the present embodiment can extend in a zigzag manner in the longitudinal direction. Such a center sipe 21 can also enhance apparent stiffness of the center block 3R. For example, the center sipe 21 may extend in a zigzag manner or linearly in the tire radial direction.

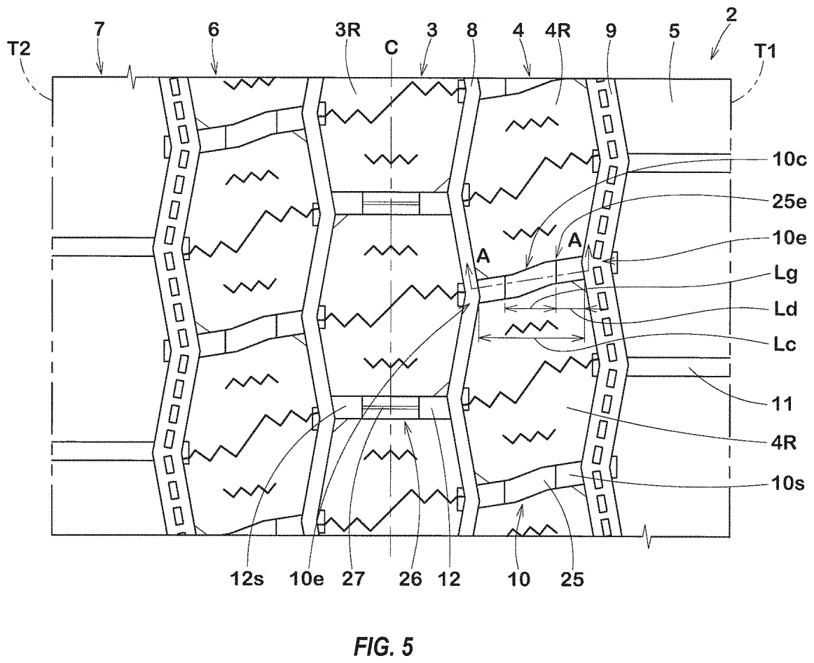

FIG. 5 is a plan view of the tread portion 2 according to another embodiment. The same components as those in the above-described embodiment are denoted by the same reference characters, and the description thereof is omitted. As shown in FIG. 5, the tread portion 2 of the present embodiment can include the center land portion 3, the first middle land portion 4, the first shoulder land portion 5, the second middle land portion 6, and the second shoulder land portion 7. In addition, the tread portion 2 can include, for example, the center circumferential grooves 8, the shoulder circumferential grooves 9, the first middle lateral grooves 10, the first shoulder lateral grooves 11, and the center lateral grooves 12.

The first middle lateral groove 10 of the present embodiment can connect the first middle blocks 4R adjacent to the first middle lateral groove 10 to each other, and can be provided with a groove bottom raised portion 25 formed by raising a groove bottom 10s. Such a groove bottom raised portion 25 can further inhibit the first middle block 4R from falling down.

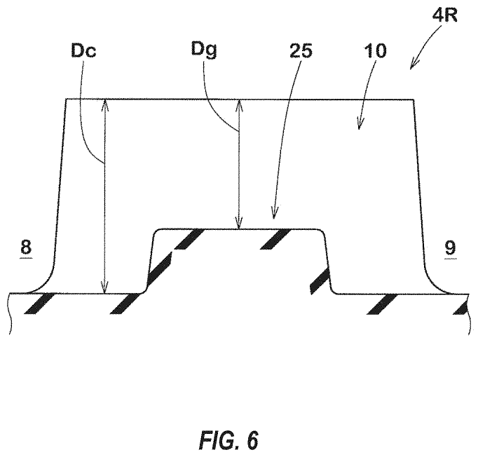

FIG. 6 is a cross-sectional view taken along a line A-A in FIG. 5. As shown in FIG. 6, a depth Dg to the groove bottom raised portion 25 can be not smaller than 40% of the groove depth Da (shown in FIG. 1) of the center circumferential groove 8, for instance, not smaller than 45% thereof, and can be not larger than 60% thereof, for instance, not larger than 55% thereof. The depth Dg of the groove bottom raised portion 25 may be not smaller than 40% of the groove depth Da of the center circumferential groove 8, for instance, whereby the basic wet performance can be maintained to be high. The depth Dg of the groove bottom raised portion 25 may be not larger than 60% of the groove depth Da of the center circumferential groove 8, which can effectively inhibit the first middle block 4R from falling down. A groove depth Dc of the first middle lateral groove 10 can be 80% to 120% of the groove depth Da of the center circumferential groove 8. The groove depth Dc of the first middle lateral groove 10 of the present embodiment can be equal to the groove depth Da of the center circumferential groove 8.

As shown in FIG. 5, a length Lg of the groove bottom raised portion 25 in the tire axial direction can be not smaller than 40% of a length Lc of the first middle lateral groove 10 in the tire axial direction, for instance, not smaller than 45% thereof, and can be not larger than 60% thereof, for instance, not larger than 55% thereof. Thus, the above effect can be more effectively achieved.

The groove bottom raised portion 25 can be, for example, disposed in a center portion 10c of the first middle lateral groove 10 in the tire axial direction. The groove bottom raised portion 25 can be disposed at a position separated from both ends 10e and 10e of the first middle lateral groove 10 in the tire axial direction. A separation distance Ld between the one end 10e of the first middle lateral groove 10 and a corresponding one of ends 25e of the groove bottom raised portion 25 in the tire axial direction can be not smaller than 15% of the length Lc of the first middle lateral groove 10 in the tire axial direction, for instance, not smaller than 20% thereof, and can be not larger than 35% thereof, for instance, not larger than 30% thereof.

The center lateral groove 12 of the present embodiment can also connect the center blocks 3R adjacent to the center lateral groove 12 to each other, and can be provided with a groove bottom raised portion 26 formed by raising a groove bottom 12s.

The groove bottom raised portion 26 of the center lateral groove 12 can be provided with a sipe 27. Such a sipe 27 can inhibit the wet performance from being lowered due to the groove bottom raised portion 26.

Although the particularly preferred embodiments of the present disclosure have been described in detail above, the present disclosure is not limited to the embodiments shown in the drawings, and various modifications can be made to implement the present disclosure.

The present disclosure has been made in view of the above-described problem in the background section, and an object of the present disclosure, among one or more objects, can be to provide a heavy duty tire having enhanced center wear resistance and improved life performance.

The heavy duty tire according to the present disclosure having the above-described configuration can enhance center wear resistance to improve life performance.

### Examples

Heavy duty tires each having a basic structure shown in FIG. 1 were produced as test tires, and tested for center wear resistance. A test method and common specifications are as follows.

Tire size: 295/75R22.5

Rim: 8.25×22.5

Internal pressure: 750 kPa

Da, Db: 25 mm

R1/R2: 1.00

R3/R4: 1.00

<Center Wear Resistance>

The test tires were mounted to the first drive axle of a trailer head. A test driver drove the vehicle, and a groove depth of each of the center lateral groove and the center circumferential groove was measured after driving. The results are indicated as indexes with an average value of the groove depths in Comparative Example 1 being regarded as 100. The higher the value is, the better the center wear resistance is.

Vehicle: 10t truck (loaded with 50% of the standard payload)

Running distance: 50000 km

The results of the tests are shown in Table 1.

TABLE 1

| | Comp. | Comp. | | | | | | | | | |
|---|---|---|---|---|---|---|---|---|---|---|---|
| | Ex. 1 | Ex. 2 | Ex. 1 | Ex. 2 | Ex. 3 | Ex. 4 | Ex. 5 | Ex. 6 | Ex. 7 | Ex. 8 | Ex. 9 |
| Wa/Da | 0.26 | 0.21 | 0.21 | 0.25 | 0.18 | 0.21 | 0.21 | 0.21 | 0.21 | 0.21 | 0.21 |
| Lb/La | 0.80 | 0.70 | 0.80 | 0.80 | 0.80 | 0.85 | 0.80 | 0.80 | 0.80 | 0.80 | 0.80 |
| R3/R1 | 0.17 | 0.17 | 0.17 | 0.17 | 0.17 | 0.17 | 0.21 | 0.17 | 0.17 | 0.17 | 0.17 |
| Lp/Wt | 0.43 | 0.43 | 0.43 | 0.43 | 0.43 | 0.43 | 0.43 | 0.30 | 0.43 | 0.43 | 0.43 |
| Dg/Da (%) | 50 | 50 | 50 | 50 | 50 | 50 | 50 | 50 | 70 | 50 | 50 |
| Ds/Da | 0.75 | 0.75 | 0.75 | 0.75 | 0.75 | 0.75 | 0.75 | 0.75 | 0.75 | 0.95 | 0.75 |
| Ya/Yb | 1.15 | 1.15 | 1.15 | 1.15 | 1.15 | 1.15 | 1.15 | 1.15 | 1.15 | 1.15 | 0.90 |
| Center wear | 100 | 100 | 115 | 113 | 110 | 110 | 112 | 111 | 111 | 112 | 112 |
| resistance [Index: | | | | | | | | | | | |
| larger number is | | | | | | | | | | | |
| better] | | | | | | | | | | | |

As shown in Table 1, it has been understood that the tire of each example had better center wear resistance than the tire of each comparative example. Therefore, the results indicate that the tires of the examples had better life performance.

[Appendix]

The present disclosure includes the following aspects.

### [Disclosure 1]

A heavy duty tire including a tread portion, in which

the tread portion includes: a center land portion disposed closest to a tire equator; a first middle land portion disposed adjacent to the center land portion via a center circumferential groove; a first shoulder land portion disposed adjacent to the first middle land portion via a shoulder circumferential groove and having a first tread end; and a first middle lateral groove and a first shoulder lateral groove that demarcate the first middle land portion and the first shoulder land portion into first middle blocks and first shoulder blocks, respectively,

in a 5% internal pressure state in which the heavy duty tire is fitted to a normal rim and adjusted to have 5% of a normal internal pressure, a radius R1 of curvature of a ground-contact surface profile P1 of the center land portion, a radius R2 of curvature of a ground-contact surface profile P2 of an inner region of the first middle block in a tire axial direction, a radius R3 of curvature of a ground-contact surface profile P3 of an outer region of the first middle block in the tire axial direction, and a radius R4 of curvature of a ground-contact surface profile P4 of the first shoulder block satisfy the following formulas (1) to (3),

a groove depth of each of the center circumferential groove and the shoulder circumferential groove is not smaller than 21 mm,

a ratio (Wa/Da) of a groove width Wa of the center circumferential groove to a groove depth Da of the center circumferential groove is not larger than 0.25, and

a ratio (Lb/La) of a maximum length Lb in the tire axial direction to a maximum length La in a tire circumferential direction in each first middle block is larger than 0.75.

0.95≤(R1/R2)≤1.05 (1)

0.95≤(R3/R4)≤1.05 (2)

R1>R3 (3)

### [Disclosure 2]

The heavy duty tire according to Disclosure 1, in which

the ground-contact surface profile P2 and the ground-contact surface profile P3 intersect at an inflection point, and

a distance from the tire equator to the inflection point in the tire axial direction is 0.35 to 0.50 times a tread half-width Wt that is a distance from the tire equator to the first tread end in the tire axial direction.

### [Disclosure 3]

The heavy duty tire according to Disclosure 1 or 2, in which a ratio (R3/R1) of the radius R3 of curvature of the ground-contact surface profile P3 of the first middle block to the radius R1 of curvature of the ground-contact surface profile P1 of the center land portion is 0.14 to 0.20.

### [Disclosure 4]

The heavy duty tire according to any one of Disclosures 1 to 3, in which

the first middle block is provided with a first middle sipe crossing the first middle block, and

the first middle sipe extends in a zigzag manner along a longitudinal direction and a tire radial direction.

### [Disclosure 5]

The heavy duty tire according to any one of Disclosures 1 to 4, in which

the first middle lateral groove connects the first middle blocks adjacent to the first middle lateral groove to each other, and is provided with a groove bottom raised portion formed by raising a groove bottom.

### [Disclosure 6]

The heavy duty tire according to any one of Disclosures 1 to 5, in which a depth of the groove bottom raised portion is 40% to 60% of the groove depth of the center circumferential groove.

### [Disclosure 7]

The heavy duty tire according to any one of Disclosures 1 to 6, wherein the groove width Wa of the center circumferential groove decreases in a tire radial direction, and/or a groove width of the shoulder circumferential groove decreases in the tire radial direction.

### [Disclosure 8]

The heavy duty tire according to any one of Disclosures 1 to 7, wherein the groove width Wa of the center circumferential groove decreases at all times in the tire radial direction to a bottom of the center circumferential groove.

### [Disclosure 9]

The heavy duty tire according to any one of Disclosures 1 to 8, wherein the groove width Wa of the center circumferential groove decreases in the tire radial direction according to a first pattern, and the groove width of the shoulder circumferential groove decreases in the tire radial direction according to a second pattern different from the first pattern.

### [Disclosure 10]

The heavy duty tire according to any one of Disclosures 1 to 9, wherein the groove width Wa of the center circumferential groove at a first ground-contact surface associated with the first ground-contact surface profile is less than a groove width of the shoulder circumferential groove at a second ground-contact surface associated with the second ground-contact surface profile.

[Disclosure 11] A tread portion of a heavy duty tire, the tread portion comprising:

a center land portion;

a first middle land portion adjacent to the center land portion via a center circumferential groove;

a first shoulder land portion adjacent to the first middle land portion via a shoulder circumferential groove and having a first tread end; and

a first middle lateral groove and a first shoulder lateral groove that demarcate the first middle land portion and the first shoulder land portion into first middle blocks and first shoulder blocks, respectively,

in a 5% internal pressure state in which the heavy duty tire is fitted to a normal rim and adjusted to have 5% of a normal internal pressure, a first radius R1 of curvature of a first ground-contact surface profile of the center land portion, a second radius R2 of curvature of a second ground-contact surface profile of an inner region of the first middle block in a tire axial direction, a third radius R3 of curvature of a third ground-contact surface profile of an outer region of the first middle block in the tire axial direction, and a fourth radius R4 of curvature of a fourth ground-contact surface profile of the first shoulder block satisfy the following formulas (1) to (3),

a groove depth of each of the center circumferential groove and the shoulder circumferential groove is not smaller than 21.0 mm,

a ratio (Wa/Da) of a groove width Wa of the center circumferential groove to a groove depth Da of the center circumferential groove is not larger than 0.25, and

a ratio (Lb/La) of a maximum length Lb in the tire axial direction to a maximum length La in a tire circumferential direction in each first middle block is larger than 0.75,

0.95≤(R1/R2)≤1.05 (1)

0.95≤(R3/R4)≤1.05 (2)

R1>R3 (3).

### [Disclosure 12]

The tread portion of the heavy duty tire according to Disclosure 11, wherein the second ground-contact surface profile and the third ground-contact surface profile intersect at an inflection point, and a first distance from a tire equator to the inflection point in the tire axial direction is 0.35 to 0.50 times a tread half-width Wt that is a second distance from the tire equator to the first tread end in the tire axial direction.

### [Disclosure 13]

The tread portion of the heavy duty tire according to Disclosure 11 or Disclosure 12, wherein a ratio (R3/R1) of the third radius R3 of curvature of the third ground-contact surface profile of the first middle block to the first radius R1 of curvature of the first ground-contact surface profile of the center land portion is 0.14 to 0.20.

### [Disclosure 14]

The tread portion of the heavy duty tire according to any one of Disclosures 11 to 13, wherein the first middle block has a first middle sipe crossing the first middle block, and the first middle sipe extends in a zigzag along a longitudinal direction and a tire radial direction.

### [Disclosure 15]

The tread portion of the heavy duty tire according to any one of Disclosures 11 to 14, wherein the first middle lateral groove connects the first middle blocks adjacent to the first middle lateral groove to each other, and includes a groove bottom raised portion.

### [Disclosure 16]

The tread portion of the heavy duty tire according to any one of Disclosures 11 to 15, wherein a depth to the groove bottom raised portion is 40% to 60% of the groove depth of the center circumferential groove.

### [Disclosure 17]

The tread portion of the heavy duty tire according to any one of Disclosures 11 to 16, wherein the groove width Wa of the center circumferential groove decreases in a tire radial direction, and a groove width of the shoulder circumferential groove decreases in the tire radial direction.

### [Disclosure 18]

The tread portion of the heavy duty tire according to any one of Disclosures 11 to 17, wherein the groove width Wa of the center circumferential groove decreases at all times in the tire radial direction to a bottom of the center circumferential groove.

### [Disclosure 19]

The tread portion of the heavy duty tire according to any one of Disclosures 11 to 18, wherein the groove width Wa of the center circumferential groove decreases in the tire radial direction according to a first pattern, and the groove width of the shoulder circumferential groove decreases in the tire radial direction according to a second pattern different from the first pattern.

### [Disclosure 20]

The tread portion of the heavy duty tire according to any one of Disclosures 11 to 19, wherein the groove width Wa of the center circumferential groove at a first ground-contact surface associated with the first ground-contact surface profile is less than a groove width of the shoulder circumferential groove at a second ground-contact surface associated with the second ground-contact surface profile.

What is claimed is:

1. A heavy duty tire comprising:
a tread portion, wherein
the tread portion includes:
a center land portion closest to a tire equator relative to any other land portions of the tread portion;
a first middle land portion adjacent to the center land portion via a center circumferential groove;
a first shoulder land portion adjacent to the first middle land portion via a shoulder circumferential groove and having a first tread end; and
a first middle lateral groove and a first shoulder lateral groove that demarcate the first middle land portion and the first shoulder land portion into first middle blocks and first shoulder blocks, respectively,
in a 5% internal pressure state in which the heavy duty tire is fitted to a normal rim and adjusted to have 5% of a normal internal pressure, a first radius R1 of curvature of a first ground-contact surface profile of the center land portion, a second radius R2 of curvature of a second ground-contact surface profile of an inner region of the first middle block in a tire axial direction, a third radius R3 of curvature of a third ground-contact surface profile of an outer region of the first middle block in the tire axial direction, and a fourth radius R4 of curvature of a fourth ground-contact surface profile of the first shoulder block satisfy the following formulas (1) to (3),
a groove depth of each of the center circumferential groove and the shoulder circumferential groove is not smaller than 21 mm,
a ratio (Wa/Da) of a groove width Wa of the center circumferential groove to a groove depth Da of the center circumferential groove is not larger than 0.25, and
a ratio (Lb/La) of a maximum length Lb in the tire axial direction to a maximum length La in a tire circumferential direction in each first middle block is larger than 0.75,
0.95≤(R1/R2)≤1.05 (1)
0.95≤(R3/R4)≤1.05 (2)
R1>R3 (3).

2. The heavy duty tire according to claim 1, wherein
the second ground-contact surface profile and the third ground-contact surface profile intersect at an inflection point, and
a first distance from the tire equator to the inflection point in the tire axial direction is 0.35 to 0.50 times a tread half-width Wt that is a second distance from the tire equator to the first tread end in the tire axial direction.

3. The heavy duty tire according to claim 1, wherein a ratio (R3/R1) of the third radius R3 of curvature of the third ground-contact surface profile of the first middle block to the first radius R1 of curvature of the first ground-contact surface profile of the center land portion is 0.14 to 0.20.

4. The heavy duty tire according to claim 1, wherein
the first middle block has a first middle sipe crossing the first middle block, and
the first middle sipe extends in a zigzag along a longitudinal direction and a tire radial direction.

5. The heavy duty tire according to claim 1, wherein
the first middle lateral groove connects the first middle blocks adjacent to the first middle lateral groove to each other, and includes a groove bottom raised portion.

6. The heavy duty tire according to claim 5, wherein a depth to the groove bottom raised portion is 40% to 60% of the groove depth of the center circumferential groove.

7. The heavy duty tire according to claim 1, wherein
the groove width Wa of the center circumferential groove decreases in a tire radial direction, and/or
a groove width of the shoulder circumferential groove decreases in the tire radial direction.

8. The heavy duty tire according to claim 7, wherein
the groove width Wa of the center circumferential groove decreases at all times in the tire radial direction to a bottom of the center circumferential groove.

9. The heavy duty tire according to claim 7, wherein
the groove width Wa of the center circumferential groove decreases in the tire radial direction according to a first pattern, and
the groove width of the shoulder circumferential groove decreases in the tire radial direction according to a second pattern different from the first pattern.

10. The heavy duty tire according to claim 1, wherein
the groove width Wa of the center circumferential groove at a first ground-contact surface associated with the first ground-contact surface profile is less than a groove width of the shoulder circumferential groove at a second ground-contact surface associated with the second ground-contact surface profile.

11. A tread portion of a heavy duty tire, the tread portion comprising:
a center land portion;
a first middle land portion adjacent to the center land portion via a center circumferential groove;
a first shoulder land portion adjacent to the first middle land portion via a shoulder circumferential groove and having a first tread end; and
a first middle lateral groove and a first shoulder lateral groove that demarcate the first middle land portion and the first shoulder land portion into first middle blocks and first shoulder blocks, respectively,
in a 5% internal pressure state in which the heavy duty tire is fitted to a normal rim and adjusted to have 5% of a normal internal pressure, a first radius R1 of curvature of a first ground-contact surface profile of the center land portion, a second radius R2 of curvature of a second ground-contact surface profile of an inner region of the first middle block in a tire axial direction, a third radius R3 of curvature of a third ground-contact surface profile of an outer region of the first middle block in the tire axial direction, and a fourth radius R4 of curvature of a fourth ground-contact surface profile of the first shoulder block satisfy the following formulas (1) to (3),
a groove depth of each of the center circumferential groove and the shoulder circumferential groove is not smaller than 21.0 mm,
a ratio (Wa/Da) of a groove width Wa of the center circumferential groove to a groove depth Da of the center circumferential groove is not larger than 0.25, and
a ratio (Lb/La) of a maximum length Lb in the tire axial direction to a maximum length La in a tire circumferential direction in each first middle block is larger than 0.75,
0.95≤(R1/R2)≤1.05 (1)
0.95≤(R3/R4)≤1.05 (2)
R1>R3 (3).

12. The tread portion of the heavy duty tire according to claim 11, wherein
the second ground-contact surface profile and the third ground-contact surface profile intersect at an inflection point, and
a first distance from a tire equator to the inflection point in the tire axial direction is 0.35 to 0.50 times a tread half-width Wt that is a second distance from the tire equator to the first tread end in the tire axial direction.

13. The tread portion of the heavy duty tire according to claim 11, wherein a ratio (R3/R1) of the third radius R3 of curvature of the third ground-contact surface profile of the first middle block to the first radius R1 of curvature of the first ground-contact surface profile of the center land portion is 0.14 to 0.20.

14. The tread portion of the heavy duty tire according to claim 11, wherein
the first middle block has a first middle sipe crossing the first middle block, and
the first middle sipe extends in a zigzag along a longitudinal direction and a tire radial direction.

15. The tread portion of the heavy duty tire according to claim 11, wherein
the first middle lateral groove connects the first middle blocks adjacent to the first middle lateral groove to each other, and includes a groove bottom raised portion.

16. The tread portion of the heavy duty tire according to claim 15, wherein a depth to the groove bottom raised portion is 40% to 60% of the groove depth of the center circumferential groove.

17. The tread portion of the heavy duty tire according to claim 11, wherein
the groove width Wa of the center circumferential groove decreases in a tire radial direction, and
a groove width of the shoulder circumferential groove decreases in the tire radial direction.

18. The tread portion of the heavy duty tire according to claim 17, wherein
the groove width Wa of the center circumferential groove decreases at all times in the tire radial direction to a bottom of the center circumferential groove.

19. The tread portion of the heavy duty tire according to claim 17, wherein
the groove width Wa of the center circumferential groove decreases in the tire radial direction according to a first pattern, and
the groove width of the shoulder circumferential groove decreases in the tire radial direction according to a second pattern different from the first pattern.

20. The tread portion of the heavy duty tire according to claim 11, wherein
the groove width Wa of the center circumferential groove at a first ground-contact surface associated with the first ground-contact surface profile is less than a groove width of the shoulder circumferential groove at a second ground-contact surface associated with the second ground-contact surface profile.
